(19) United States
(12) Patent Application Publication
(10) Pub. No.: US 2024/0243387 A1
(43) Pub. Date: Jul. 18, 2024

(54) IN-VEHICLE BATTERY

(71) Applicant: SUBARU CORPORATION, Tokyo (JP)

(72) Inventor: Toshiaki NARUKE, Tokyo (JP)

(73) Assignee: SUBARU CORPORATION, Tokyo (JP)

(21) Appl. No.: 18/403,271

(22) Filed: Jan. 3, 2024

(30) Foreign Application Priority Data
Jan. 17, 2023 (JP) 2023-005361

(51) Int. Cl. H01M 10/6568; H01M 10/613; H01M 10/625; H01M 10/653; H01M 10/6555; H01M 50/207

(52) U.S. Cl. CPC H01M 10/6568; H01M 10/613; H01M 10/625; H01M 10/6555; H01M 10/653; H01M 50/207; H01M 2220/20

(57) ABSTRACT

An in-vehicle battery includes a battery module, and a temperature control mechanism. Inside the battery module, battery cells are disposed. The temperature control mechanism is located in a vicinity of the battery module and configured to cool the battery module. A flow path through which a cooling fluid passes is provided inside the temperature control mechanism. A recess or a protrusion is provided on a surface on a battery module side among wall surfaces forming the flow path. A surface of the battery module and a surface of the temperature control mechanism facing each other each have a planar shape.

### CROSS-REFERENCE TO RELATED APPLICATION

The present application claims priority from Japanese Patent Application No. 2023-005361 filed on Jan. 17, 2023, the entire contents of which are hereby incorporated by reference.

### BACKGROUND

The disclosure relates to an in-vehicle battery including a temperature control mechanism.

For example, vehicles such as electric vehicles and hybrid vehicles are equipped with in-vehicle batteries used for various purposes such as power supply for motor driving, storage of regenerated electric power, and 12-V power supply.

An in-vehicle battery includes a battery module in which multiple battery cells are incorporated. Japanese Unexamined Patent Application Publication No. 2019-114460 discloses an in-vehicle battery in which a temperature control mechanism for cooling the battery cells is disposed in the vicinity of a bottom surface of a vehicle.

### SUMMARY

An aspect of the disclosure provides an in-vehicle battery including a battery module, and a temperature control mechanism. Inside the battery module, battery cells are disposed. The temperature control mechanism is located in a vicinity of the battery module and configured to cool the battery module. A flow path through which a cooling fluid passes is provided inside the temperature control mechanism. A recess or a protrusion is provided on a surface on a battery module side among wall surfaces forming the flow path. A surface of the battery module and a surface of the temperature control mechanism facing each other each have a planar shape.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a perspective view schematically illustrating a vehicle according to an embodiment when viewed from a bottom surface;

FIG. 2 is a top view schematically illustrating an in-vehicle battery;

FIG. 3 is a cross-sectional view schematically illustrating the in-vehicle battery when viewed from a left side surface;

FIG. 4 schematically illustrates a structure of a battery module;

FIG. 5 is a cross-sectional view schematically illustrating a part of the in-vehicle battery;

FIG. 6 is a perspective view schematically illustrating a cross section of a temperature control mechanism;

FIG. 7 is a cross-sectional view schematically illustrating a part of the in-vehicle battery;

FIG. 8 is a cross-sectional view schematically illustrating an in-vehicle battery according to an embodiment when viewed from a left side surface; and

FIG. 9 is a cross-sectional view schematically illustrating a part of the in-vehicle battery.

### DETAILED DESCRIPTION

When a vehicle travels on a rough road, a rocky road, or the like having relatively large irregularities, a protruding portion of a road surface may collide with a bottom surface of the vehicle. In this case, the temperature control mechanism disposed in the vicinity of the bottom surface of the vehicle may be damaged, and temperature control such as cooling of the battery cells may be no longer sufficiently performed.

Moreover, since bottom surfaces of the battery cells have variations in height, in some cases, the battery cells cannot uniformly contact the bottom surface of the battery module or the temperature control mechanism when the battery cells are disposed. In some cases, heat is not sufficiently dissipated from the battery cells.

Accordingly, it is desirable to provide an in-vehicle battery including a temperature control mechanism that maintains or improves a temperature control function of battery cells.

An aspect of the disclosure provides an in-vehicle battery including a battery module, and a temperature control mechanism. Inside the battery module, battery cells are disposed. The temperature control mechanism is located in a vicinity of the battery module and configured to cool the battery module. A flow path through which a cooling fluid passes is provided inside the temperature control mechanism. A recess or a protrusion is provided on a surface on a battery module side among wall surfaces forming the flow path. A surface of the battery module and a surface of the temperature control mechanism facing each other each have a planar shape.

Accordingly, even when the temperature control mechanism is deformed and another wall surface comes into contact with the recess or the protrusion, a space through which the fluid passes is formed by the recess or the protrusion and the other wall surface. Moreover, the battery module and the temperature control mechanism can be in contact with each other substantially without a gap.

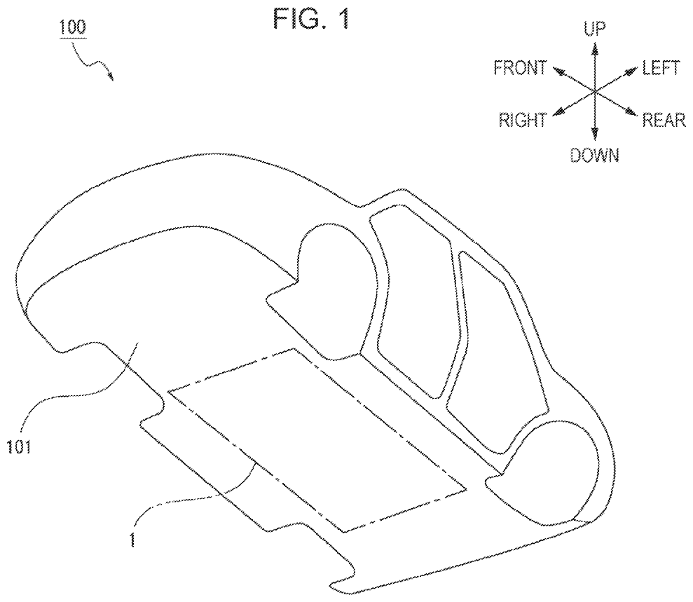

Hereinafter, embodiments will be described with reference to FIGS. 1 to 9. In the following description, a front-rear direction is indicated while a traveling direction of a vehicle 100 represents a front side, and a left-right direction is indicated with reference to the traveling direction. In addition, an up-down direction is indicated while a direction from a bottom surface side to a top surface side of the vehicle 100 represents an upward direction. Refer to the directions illustrated in the drawings.

The configurations illustrated in the drawings referred to in the description of each embodiment are schematically illustrated by extracting portions for implementing each embodiment and peripheral configurations thereof. Thus, the relationship, ratio, and the like of the thicknesses and planar dimensions of structures illustrated in the drawings are merely examples, and various modifications can be made in accordance with the design or the like within a scope not departing from the technical idea of the disclosure.

A first embodiment will be described with reference to FIGS. 1 to 7.

A vehicle 100 illustrated in FIG. 1 is, for example, an electric vehicle driven by a driving force of a motor or a hybrid vehicle driven by a driving force of a motor or an engine.

The vehicle 100 includes an in-vehicle battery 1. The in-vehicle battery 1 is disposed in the vicinity of a bottom surface 101 of the vehicle 100. A motor of the vehicle 100 is driven by electric power supplied from the in-vehicle battery 1, and tires of the vehicle 100 are rotated by a driving force of the motor. FIG. 1 omits the illustration of the motor and the tires of the vehicle 100.

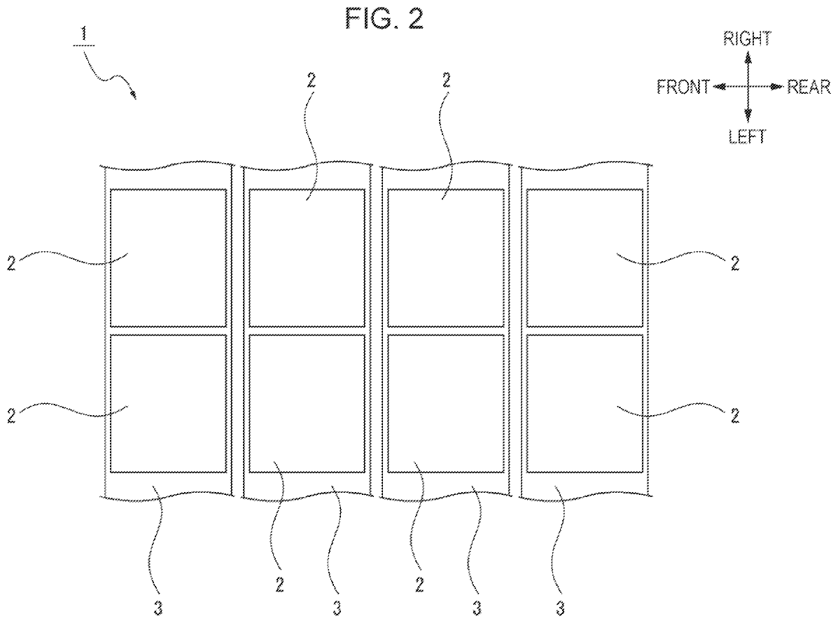

As illustrated in FIGS. 2 to 4, the in-vehicle battery 1 includes a battery module 2, a temperature control mechanism 3, a battery pack 4, and a heat transfer sheet 5.

As illustrated in FIG. 2, multiple battery modules 2 are disposed in rows and columns in the in-vehicle battery 1. The temperature control mechanism 3 that controls the temperature of the battery modules 2 is located in the vicinity of the battery modules 2. For example, in the in-vehicle battery 1, multiple laterally long temperature control mechanisms 3 are disposed in the front-rear direction, and multiple battery modules 2 are arranged in the left-right direction above each of the temperature control mechanisms 3. In the present embodiment, a case where the temperature control mechanisms 3 mainly perform temperature control of cooling the battery modules 2 will be described.

The number of battery modules 2 provided in the in-vehicle battery 1 is any number, and is not limited to eight as illustrated in FIG. 2. Alternatively, the temperature control mechanism 3 may be formed to be longitudinally long, and the multiple temperature control mechanisms 3 may be disposed in the left-right direction.

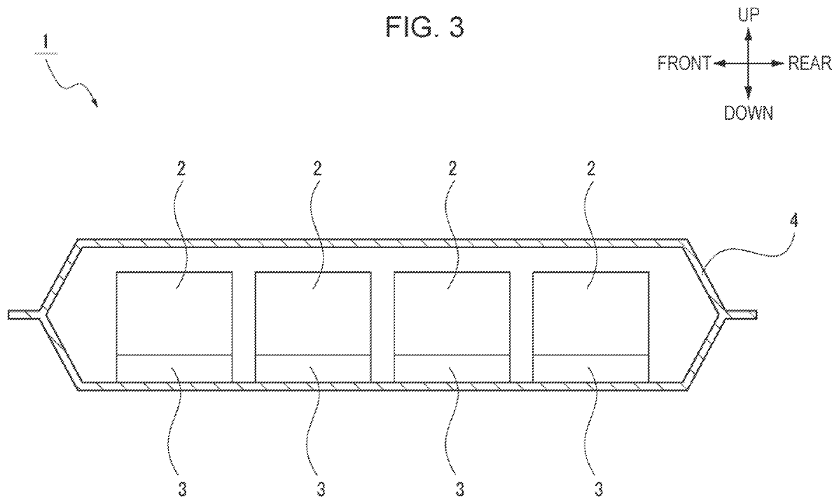

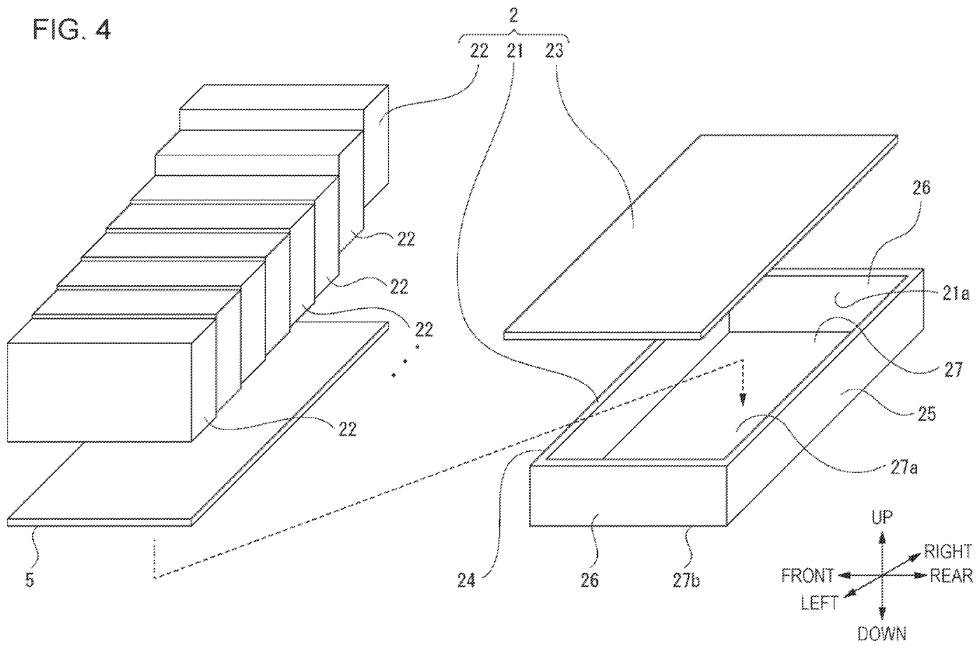

As illustrated in FIG. 3, the battery modules 2 and the temperature control mechanisms 3 are incorporated in the battery pack 4. As illustrated in FIG. 4, the heat transfer sheet 5 is disposed inside the battery module 2.

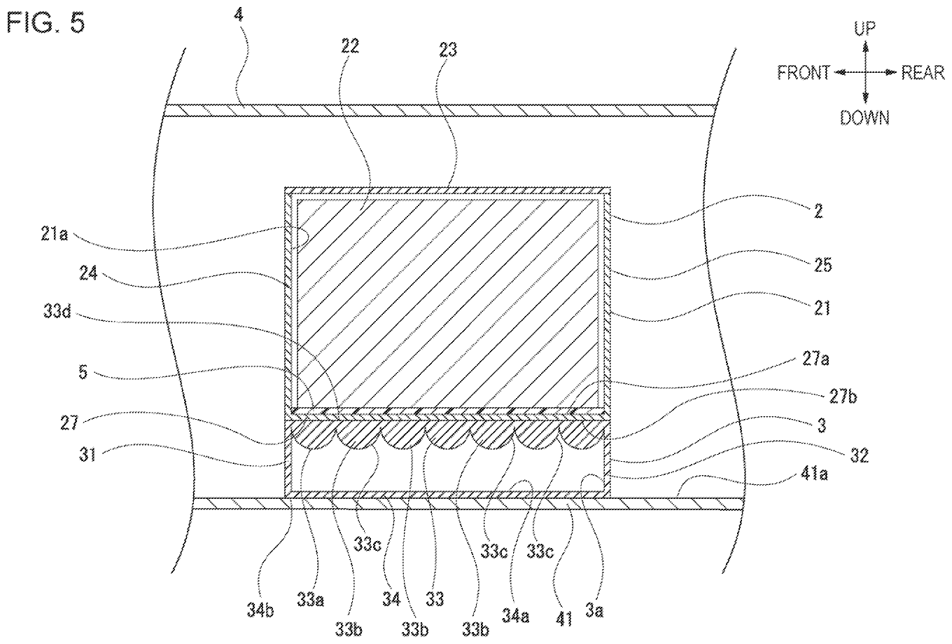

As illustrated in FIGS. 4 and 5, the battery module 2 includes a housing case 21, multiple battery cells 22, and a cover 23.

As illustrated in FIG. 4, the housing case 21 is formed in a laterally long box shape opened upward, and includes a laterally long front surface portion 24 and a laterally long rear surface portion 25 facing in the front-rear direction and spaced apart from each other in the front-rear direction, side surface portions 26 facing in the left-right direction and spaced apart from each other in the left-right direction, and a laterally long lower surface portion 27 facing in the up-down direction. An inner space of the housing case 21 is formed as a housing space 21a.

The heat transfer sheet 5 formed in a flat plate shape is disposed on an inner surface 27a of the lower surface portion 27. The heat transfer sheet 5 has thermal conductivity and elasticity, and is formed of, for example, a resin such as a urethane resin, an epoxy resin, or a silicone resin.

The multiple battery cells 22 are housed in the housing space 21a and held by the housing case 21, for example, in a state where the battery cells 22 are arranged at equal intervals in the left-right direction when a thickness direction is the left-right direction.

In a state where the battery cells 22 are held, each of the battery cells 22 is disposed on the lower surface portion 27 with the heat transfer sheet 5 interposed. Accordingly, heat generated in the battery cells 22 is efficiently transferred to the housing case 21 via the heat transfer sheet 5.

An outer surface 27b of the lower surface portion 27 is a surface that is in contact with an outer surface 33d of a top surface portion 33 of the temperature control mechanism 3 (described later) in a state where the battery module 2 is disposed on the temperature control mechanism 3 as illustrated in FIG. 5. The outer surface 27b is formed in a planar shape extending in the front-rear direction and the left-right direction.

In this case, a surface formed in a planar shape according to the embodiment of the disclosure includes a surface of completely the same plane in the entire region of the surface, but is not limited thereto, and also includes an aspect in which planarity is maintained as the entire surface. Thus, the planar shape includes, for example, an aspect in which a very small step of about several millimeters is formed in the up-down direction, an aspect in which a recess such as a hole for a function is formed in a part of the surface, and the like. The planar shape also includes an aspect in which at least a surface in contact with another object of the entire region of the surface is the same plane.

As illustrated in FIG. 4, the cover 23 is formed in a laterally long flat plate shape, and is attached to the housing case 21 in a state of closing the upper opening of the housing case 21. The housing case 21 and the cover 23 are formed of a resin, a steel sheet, or the like.

Alternatively, the battery module 2 may be formed in, for example, a longitudinally long box shape that is open upward. In this case, the multiple battery cells 22 are housed in the housing space 21a, for example, in a state of being arranged at equal intervals in the front-rear direction when a thickness direction is the front-rear direction.

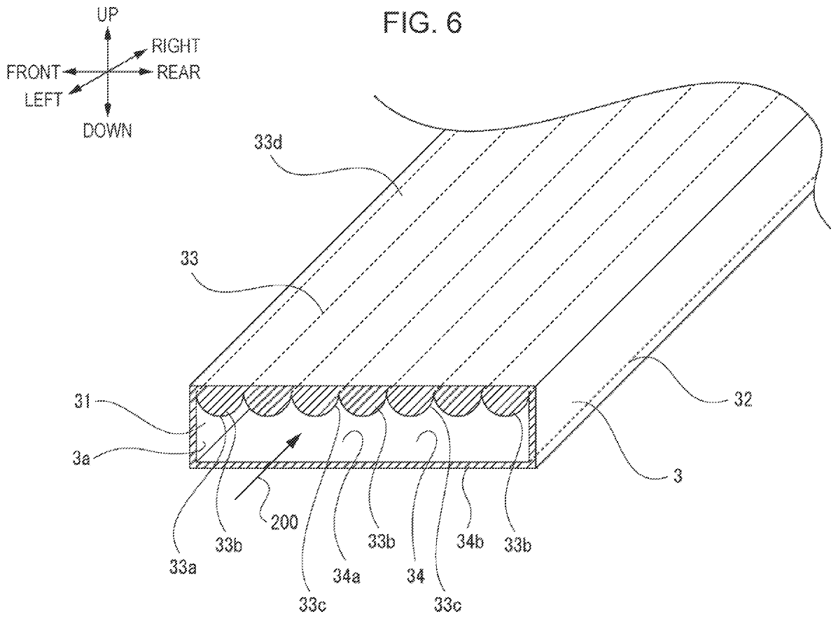

As illustrated in FIGS. 5 and 6, the temperature control mechanism 3 includes at least a laterally long front surface portion 31 and a laterally long rear surface portion 32 facing in the front-rear direction and spaced apart from each other in the front-rear direction, and a laterally long top surface portion 33 and a laterally long bottom surface portion 34 facing in the up-down direction and spaced apart from each other in the up-down direction.

The inner space of the temperature control mechanism 3 is formed as a flow path 3a through which a fluid 200 passes. The fluid 200 is a medium for controlling the temperature of the battery cells 22 disposed in the housing case 21, and is, for example, water.

Although not illustrated, for example, an inlet for the fluid 200 into the flow path 3a is provided in one end portion of the temperature control mechanism 3 in the left-right direction, and an outlet for the fluid 200 which has passed through the flow path 3a is provided in the other end. Accordingly, the fluid 200 flows mainly in the left-right direction from the inlet toward the outlet, for example, as indicated by an arrow in FIG. 6.

For example, when the temperature of the battery module 2 is higher than an appropriate temperature, the fluid 200 is made to flow into the flow path 3a of the temperature control mechanism 3, and heat from the battery module 2 is absorbed by the fluid 200. Accordingly, the battery module 2 is cooled, and the temperature of the battery module 2 is appropriately maintained.

Multiple protrusions 33b protruding downward are formed on an inner surface 33a of the top surface portion 33. The protrusions 33b are formed to extend in the left-right direction and are provided so as to be adjacent to each other in the front-rear direction. A recess 33c extending in the left-right direction is formed between the adjacent protrusions 33b.

By forming the protrusions 33b and the recesses 33c on the inner surface 33a of the top surface portion 33, the surface area of the inner surface 33a is increased as compared with a case where the inner surface 33a is formed in a planar shape.

Heat generated from the battery cells 22 housed in the battery module 2 illustrated in FIG. 5 is transferred to the top surface portion 33 via the heat transfer sheet 5 and the housing case 21. At this time, the contact area with the fluid 200 is increased by increasing the surface area of the inner surface 33a as described above. Thus, it is possible to improve heat conduction efficiency of the heat, which has been transferred to the top surface portion 33, to the fluid 200.

Since the fluid 200 flows in the left-right direction, it can be also expressed that the shapes of the protrusions 33b and the recesses 33c are formed in a flowing direction of the fluid 200.

Due to the above-described shapes of the protrusions 33b and the recesses 33c, the fluid 200 which has received the dissipated heat flows toward the outlet (not illustrated) without stagnation and without the flow being hindered by the protrusions 33b or the recesses 33c. Thus, the heat transferred to the top surface portion 33 can be efficiently dissipated.

Tips of the protrusions 33b are located to be spaced apart from an inner surface 34a of the bottom surface portion 34. An outer surface 34b of the bottom surface portion 34 is in contact with an inner surface 41a of a bottom portion 41 of the battery pack 4, and hence heat from the outside of the battery pack 4, such as heat from a road surface, may be transferred to the bottom surface portion 34.

Hence, if the tips of the protrusions 33b are in contact with the inner surface 34a of the bottom surface portion 34, for example, the heat from the road surface is transferred to the battery module 2 via the top surface portion 33, and the cooling efficiency of the battery cells 22 incorporated in the battery module 2 may be impaired. Thus, the tips of the protrusions 33b and the inner surface 34a of the bottom surface portion 34 are spaced apart from each other so that the heat from the outside is less likely to be transferred to the battery module 2.

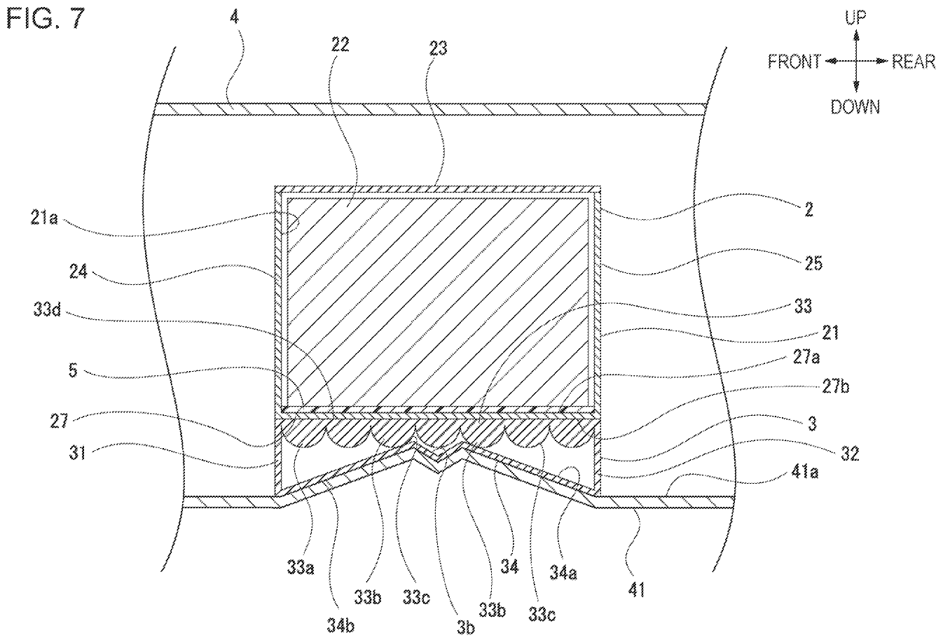

Moreover, by forming the protrusions 33b on the inner surface 33a of the top surface portion 33, even when the temperature control mechanism 3 is deformed, the heat dissipation function of the temperature control mechanism 3 can be maintained. For example, when the vehicle 100 travels on a rough road, a rocky road, or the like having large irregularities, a stone or a protruding object present on the road surface may collide with the bottom surface 101 of the vehicle 100. In this case, when an impact from below acts on the vehicle 100, as illustrated in FIG. 7, the bottom portion 41 of the battery pack 4 and the bottom surface portion 34 of the temperature control mechanism 3 may be deformed, and the bottom surface portion 34 of the temperature control mechanism 3 may come into contact with the top surface portion 33.

At this time, in the present embodiment, since the surfaces of the multiple protrusions 33b formed on the top surface portion 33 are curved surfaces, a gap 3b is formed between the recesses 33c and the inner surface 34a of the bottom surface portion 34 in a state where the top surface portion 33 and the bottom surface portion 34 are in contact with each other.

Since the gap 3b is formed in this way, the flow path 3a of the fluid 200 can be secured by the gap 3b even after the temperature control mechanism 3 is deformed, and the heat dissipation efficiency of the heat transferred to the top surface portion 33 can be maintained. In the present embodiment, an example in which the cross-sectional shape of the protrusion 33b is semi-circular has been described. However, the shape of the protrusion 33b may be any shape as long as the gap 3b is generated in the state where the bottom surface portion 34 is in contact with the top surface portion 33. For example, the cross-sectional shape of the protrusion 33b may be any of various shapes, such as a rectangular shape and a triangular shape.

As illustrated in FIG. 5, the outer surface 33d of the top surface portion 33 of the temperature control mechanism 3 is in contact with the outer surface 27b of the lower surface portion 27 of the battery module 2 in the state where the battery module 2 is disposed above the temperature control mechanism 3. The outer surface 33d is formed in a planar shape extending in the front-rear direction and the left-right direction.

Since the outer surface 27b and the outer surface 33d each are formed in a planar shape, the outer surface 27b and the outer surface 33d are in contact with each other substantially without a gap. Accordingly, the heat from the battery cells 22 can be efficiently transferred from the lower surface portion 27 to the top surface portion 33. Thus, the cooling efficiency of the battery cells 22 can be improved.

Alternatively, the temperature control mechanism 3 may be formed in a longitudinally long shape extending in the front-rear direction. In this case, for example, an inlet for the fluid 200 into the flow path 3a is provided in one end portion in the front-rear direction of the temperature control mechanism 3, and an outlet for the fluid 200 which has passed through the flow path 3a is provided in the other end portion. At this time, the fluid 200 flows mainly in the front-rear direction from the inlet toward the outlet.

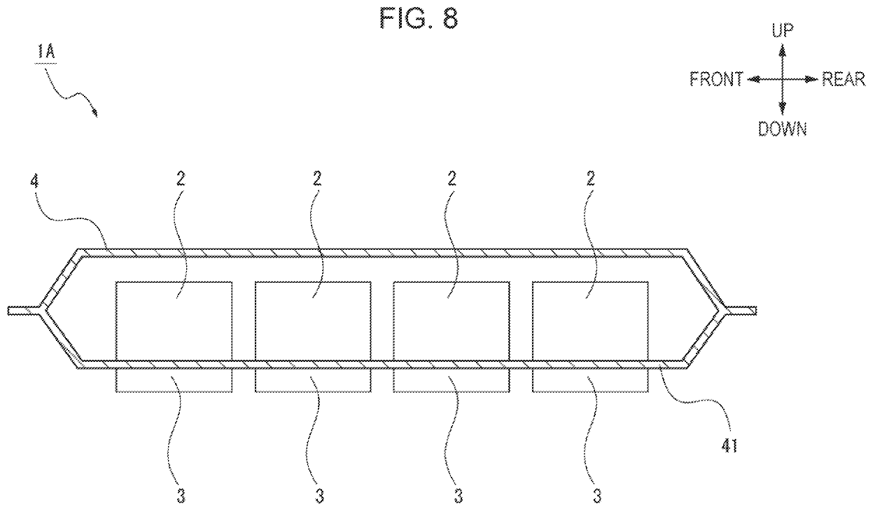

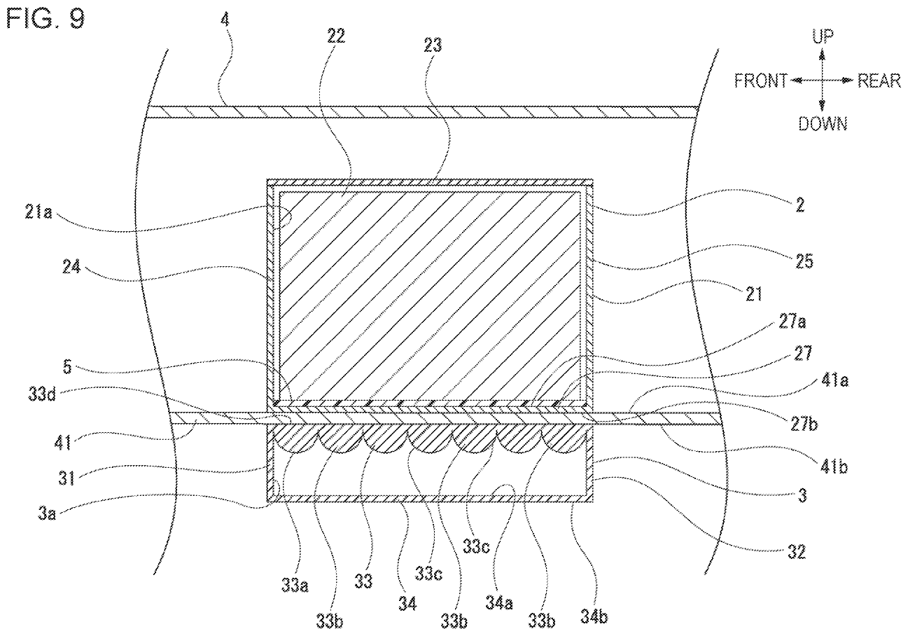

A second embodiment will be described with reference to FIGS. 8 and 9. In the following description, the description of the configuration common to the in-vehicle battery 1 of the first embodiment will be omitted.

As illustrated in FIG. 8, an in-vehicle battery 1A of the present embodiment is different from the configuration of the first embodiment in that a temperature control mechanism 3 is disposed outside a battery pack 4. A battery module 2 is incorporated in the battery pack 4, and the battery module 2 and the temperature control mechanism 3 are disposed so as to face each other via the battery pack 4.

By disposing the temperature control mechanism 3 outside the battery pack 4 in this way, for example, even when the temperature control mechanism 3 is damaged by an impact from below the vehicle 100, and a fluid 200 leaks from the temperature control mechanism 3, it is possible to prevent the fluid 200 from flowing into a battery cell 22 or the like that is an electrically charged part of the battery module 2.

Moreover, as illustrated in FIG. 9, an outer surface 27b of a lower surface portion 27 of the battery module 2 is in contact with an inner surface 41a of a bottom portion 41 of the battery pack 4. At this time, the outer surface 27b and the inner surface 41a each are formed in a planar shape and are in contact with each other substantially without a gap.

In addition, an outer surface 33d of a top surface portion 33 of the temperature control mechanism 3 is in contact with an outer surface 41b of the bottom portion 41 of the battery pack 4. At this time, the outer surface 33d and the outer surface 41b each are formed in a planar shape and are in contact with each other substantially without a gap.

Hence, the battery module 2, the battery pack 4, and the temperature control mechanism 3 are in contact with each other substantially without a gap. Accordingly, heat generated from the battery cell 22 is efficiently transferred from the lower surface portion 27 to the top surface portion 33 via the bottom portion 41. Thus, it is possible to improve cooling efficiency of the battery cell 22 in a state where the temperature control mechanism 3 is disposed outside the battery pack 4.

Summary and modifications of the above embodiments will be described.

As illustrated in FIGS. 2, 3, 8, and the like, an in-vehicle battery 1, 1A according to each of the embodiments includes a battery module 2 inside which multiple battery cells 22 are disposed, and a temperature control mechanism 3 that is located in the vicinity of the battery module 2 and that cools the battery module 2.

Moreover, as illustrated in FIGS. 5, 6, 9, and the like, a flow path 3a through which a cooling fluid 200 passes is formed inside the temperature control mechanism 3. Among wall surfaces including a front surface portion 31, a rear surface portion 32, a top surface portion 33, and a bottom surface portion 34 forming the flow path 3a, a protrusion 33b and a recess 33c are formed on an inner surface 33a of the top surface portion 33 on a battery module 2 side.

Accordingly, as illustrated in FIG. 7, even when the temperature control mechanism 3 is deformed and the bottom surface portion 34 comes into contact with the top surface portion 33, a gap 3b is formed by the protrusion 33b and the recess 33c formed on the inner surface 33a of the top surface portion 33, and the flow path 3a of the fluid 200 is secured.

Thus, for example, even when the temperature control mechanism 3 disposed in the vicinity of a bottom surface 101 of a vehicle 100 is deformed due to the vehicle 100 receiving an impact from below, it is possible to maintain heat dissipation efficiency of heat transferred from the battery module 2 to the top surface portion 33.

Moreover, as illustrated in FIG. 6 and the like, the protrusion 33b and the recess 33c formed on the inner surface 33a of the top surface portion 33 extend in a flowing direction of the fluid 200.

Accordingly, the fluid 200 which has received the dissipated heat passes through the flow path 3a without the flow being hindered by the protrusion 33b or the recess 33c. Thus, the heat dissipation efficiency of the temperature control mechanism 3 can be improved.

In each embodiment, as illustrated in FIGS. 5 and 9, the example in which the recess 33c is formed by providing the multiple protrusions 33b on the inner surface 33a of the top surface portion 33 has been described. However, for example, a recess 33c may be formed by forming a groove in the inner surface 33a without providing the protrusions 33b.

As illustrated in FIGS. 3, 5, and the like, the in-vehicle battery 1 of the first embodiment includes a battery pack 4 inside which the battery module 2 and the temperature control mechanism 3 are disposed. An outer surface 27b of the battery module 2 and an outer surface 33d of the temperature control mechanism 3 facing each other each are formed in a planar shape, and the outer surface 27b is in contact with the outer surface 33d.

Accordingly, the outer surface 27b and the outer surface 33d are in contact with each other substantially without a gap, and the heat transferred from the battery cell 22 can be efficiently transferred from the lower surface portion 27 to the top surface portion 33. Thus, cooling efficiency of the battery module 2 by the temperature control mechanism 3 can be improved.

In contrast, as illustrated in FIGS. 8 and 9, the in-vehicle battery 1A according to the second embodiment includes a battery pack 4 inside which the battery module 2 is disposed, and the battery module 2 and the temperature control mechanism 3 are disposed to face each other with a bottom portion 41 as a wall surface of the battery pack 4 interposed.

Accordingly, even when the temperature control mechanism 3 is damaged due to a factor such as an impact from the outside and the fluid 200 leaks out, since the battery module 2 is incorporated in the battery pack 4, the leaking fluid 200 does not flow into an electrically charged part such as the battery cell 22 of the battery module 2. Thus, it is possible to protect the electrically charged part of the battery module 2, for example, in a case of an abnormality or the like of the temperature control mechanism 3.

Moreover, by disposing the temperature control mechanism 3 outside the battery pack 4, even when the damaged temperature control mechanism 3 is to be replaced, the temperature control mechanism 3 can be removed and replaced without removing the battery pack 4. Thus, it is possible to reduce the number of steps in repairing the in-vehicle battery 1A and to improve workability.

In the in-vehicle battery 1A, as illustrated in FIG. 9 and the like, an inner surface 41a of the bottom portion 41 of the battery pack 4 in contact with the battery module 2 is formed in a planar shape, and an outer surface 41b of the battery pack 4 in contact with the temperature control mechanism 3 is formed in a planar shape.

Accordingly, the lower surface portion 27 of the battery module 2 and the bottom portion 41 of the battery pack 4 are in contact with each other substantially without a gap, and the bottom portion 41 of the battery pack 4 and the top surface portion 33 of the temperature control mechanism 3 are in contact with each other substantially without a gap. Thus, since the mutual contact areas can be secured, the heat generated from the battery module 2 can be efficiently transferred to the temperature control mechanism 3 via the battery pack 4.

Moreover, as illustrated in FIGS. 4, 5, 9, and the like, the in-vehicle battery 1, 1A according to each of the embodiments includes a heat transfer sheet 5 having thermal conductivity and having elasticity, and the battery cell 22 is disposed in the battery module 2 with the heat transfer sheet 5 interposed.

The heat transfer sheet 5 can efficiently transfer the heat generated from the battery cell 22 to the temperature control mechanism 3 via the housing case 21. Thus, the battery cell 22 that generates heat can be maintained at an appropriate temperature.

At this time, since the heat transfer sheet 5 is in contact with the battery cell 22, the heat generated from the battery cell 22 can be directly absorbed. For example, this is effective when the battery cell 22 rapidly generates heat due to an abnormality or the like because the heat can be directly absorbed.

Moreover, since the heat transfer sheet 5 is formed is formed of, for example, a resin and has elasticity, the heat transfer sheet 5 absorbs variations in height of the bottom surfaces of the battery cells 22 arranged on the heat transfer sheet 5. Thus, the multiple battery cells 22 can be stably disposed in the housing case 21.

Moreover, since the protrusions 33b are formed in the temperature control mechanism 3 and thus the temperature control mechanism 3 has a large heat capacity, it is possible to prevent the temperature of the battery cells 22 from becoming lower than an appropriate temperature for a certain period of time, for example, when the vehicle 100 is stopped in a cold environment outside the vehicle. For example, in a state where the vehicle 100 is stopped, the temperature control function of the temperature control mechanism 3 is also stopped. Even in such a case, each battery cell 22 can be maintained at an appropriate temperature by the heat of the heat transfer sheet 5 absorbed before the stop.

The effects described in the embodiments of the disclosure are merely examples, and the effects of the disclosure are not limited thereto. Other effects may be attained, or the effects described in the embodiments of the disclosure may be partially attained. Moreover, the combinations of the configurations described in the embodiments may be partially used to address the problems.

According to the embodiments of the disclosure, the temperature control of the battery cell can be maintained even when the temperature control mechanism is damaged.

1. An in-vehicle battery comprising:
a battery module inside which battery cells are disposed; and
a temperature control mechanism located in a vicinity of the battery module and configured to cool the battery module,
wherein a flow path through which a cooling fluid passes is provided inside the temperature control mechanism,
wherein a recess or a protrusion is provided on a surface on a battery module side among wall surfaces forming the flow path, and
wherein a surface of the battery module and a surface of the temperature control mechanism facing each other each have a planar shape.

2. The in-vehicle battery according to claim 1, comprising:
a heat transfer sheet having thermal conductivity and elasticity,
wherein the battery cells are disposed in the battery module with the heat transfer sheet interposed.

3. The in-vehicle battery according to claim 1, comprising:
a battery pack inside which the battery module and the temperature control mechanism are disposed,
wherein the surface of the battery module and the surface of the temperature control mechanism facing each other are in contact with each other.

4. The in-vehicle battery according to claim 2, comprising:
a battery pack inside which the battery module and the temperature control mechanism are disposed,
wherein the surface of the battery module and the surface of the temperature control mechanism facing each other are in contact with each other.

5. The in-vehicle battery according to claim 1, comprising:
a battery pack inside which the battery module is disposed,
wherein the battery module and the temperature control mechanism are disposed to face each other with a wall surface of the battery pack interposed,
wherein a surface of the battery pack in contact with the battery module has a planar shape, and
wherein a surface of the battery pack in contact with the temperature control mechanism has a planar shape.

6. The in-vehicle battery according to claim 2, comprising:
a battery pack inside which the battery module is disposed,
wherein the battery module and the temperature control mechanism are disposed to face each other with a wall surface of the battery pack interposed,
wherein a surface of the battery pack in contact with the battery module has a planar shape, and
wherein a surface of the battery pack in contact with the temperature control mechanism has a planar shape.

7. The in-vehicle battery according to claim 1,
wherein the recess or the protrusion is provided in a flow direction of the fluid.

8. The in-vehicle battery according to claim 2,
wherein the recess or the protrusion is provided in a flow direction of the fluid.
